(19) United States
(12) Patent Application Publication
(10) Pub. No.: US 2008/0166028 A1
(43) Pub. Date: Jul. 10, 2008

(54) Pressure actuated biometric sensor

(76) Inventors: Joseph J. Turek, Palmer, MA (US); Katrina S. Champagne, Palmer, MA (US); Robert J. Encamacion, Van Nuys, CA (US); Richard G. Wood, Houston, TX (US)

Correspondence Address: DR. RICHARD G. WOOD;THE MATTHEWS FIRM, 2000 BERING DRIVE, SUITE 700, HOUSTON, TX, 77057, US

(21) Appl. No.: 11/651,907

(22) Filed: Jan. 10, 2007

(51) Int. Cl. G06K 9/00

(52) U.S. Cl. 382/124

(57) ABSTRACT

The method and system disclosed herein decreases the rejection rate in fingerprint capturing and authentication by a pressure actuated fingerprint sensing module. The biometric device for fingerprint recognition of a user comprises a fingerprint sensing module for capturing the fingerprint image of the user at a pre-specified pressure, or a pre-specified pressure range. The fingerprint sensing module comprises a fingerprint capturing module, a pressure sensing module, a sensor memory and a sensor controlling module. The fingerprint capturing module captures the fingerprint when the pressure applied by the finger reaches the pre-specified pressure, or when the applied pressure falls within the pre-specified pressure range. The pressure sensing module measures the pressure applied on the fingerprint capturing module. The sensor memory stores a pre-defined set of pressures or pressure ranges. The sensor controlling module actuates the capture of the fingerprint image at a pre-specified pressure or in a pressure range.

### BACKGROUND

This invention, in general, relates to a method and system of fingerprint recognition, and in particular to a technique of increasing the accuracy of biometric identification by actuating the fingerprint capturing module at a pre-specified pressure(s) or at a pre-specified pressure range.

For biometric identification, most sensors require a user to press and hold their finger against the sensor, momentarily, with no or minimal movement of the finger. Pressure applied to the sensor above a below or above a certain pressure, or pressure range results in distortion of the fingerprint image and a higher biometric identification rejection rate. Multiple attempts for a successful recognition inconvenience the user and the security system personnel responsible for the biometric identification. Therefore, there is a need for a fingerprint recognition system with lower biometric identification rejection rate.

A fingerprint capturing module uses a press and hold method to capture fingerprints. Due to the variation in pressure applied on the sensor by the finger, the captured fingerprint may differ from a previously registered fingerprint template stored in the fingerprint database. This results in a higher rate of rejection in existing fingerprint authentication systems using existing biometric scanning techniques.

If the pressure applied on the fingerprint capturing module sensor is higher than the optimal pressure, the valleys and ridges of the finger gets flattened, resulting in distorted or misrepresented fingerprints. Image distortion occurs due to excess pressure applied on the fingerprint capturing module resulting in elastic deformation of the fingerprint image captured by the fingerprint capturing module. There is a need to overcome such distortion caused by application of pressure in excess of an optimal pressure.

If the pressure applied by the finger on the fingerprint capturing module is low, the image of the valleys and ridges of the finger are not fully captured. Hence, if the users press their fingers against the scanner lightly or at a pressure less than the optimum pressure, a recognition failure may occur. In order to improve the accuracy in fingerprint recognition, there exists a need for a system and method to overcome the distortions in the captured fingerprint image that may occur due to sub-optimal or pressure in excess of the optimal pressure applied on the fingerprint capture device.

### SUMMARY

The method and system disclosed herein decreases the rejection rate in fingerprint capturing and authentication by the use of a pressure actuated fingerprint sensing module. The biometric device for fingerprint recognition of a user comprises a fingerprint sensing module for capturing the fingerprint image of the user at a pre-specified pressure. The fingerprint sensing module comprises a fingerprint capturing module, a pressure sensing module, a sensor memory and a sensor controlling module. The fingerprint capturing module captures the fingerprint when the pre-specified pressure is reached. The pressure sensing module measures the pressure applied by the finger on the fingerprint capturing module. The sensor memory stores a pre-defined set of pressures or pressure ranges. The sensor controlling module actuates the capture of the fingerprint image at one of the pre-specified pressures or pressure ranges.

The method and system disclosed herein for capturing fingerprints ensures authentication reliability by minimizing the false rejection rate.

The method and system disclosed herein overcomes the problem of image distortion occurring due to sub-optimal or excess pressure applied by the finger on the fingerprint capturing module. The system captures the fingerprint image at a pre-specified pressure, hence there is no elastic deformation of the fingerprint image caused by the excess pressure exerted on the fingerprint-capturing module.

In one embodiment of the invention, the method and system disclosed herein allows the capture of fingerprint when the finger is applied on the sensor of the fingerprint scanning module at different pre-specified pressures to create a fingerprint template comprising a plurarity of fingerprints at the different pre-specified pressures of a user during registration.

In another embodiment of the invention the method and system disclosed herein allows the capture of the fingerprint when the finger is applied on the sensor of the fingerprint capturing module within a pre-specified pressure range. Capturing the fingerprint in a plurality of pre-specified pressure ranges reduces the false rejection rate to a greater extent. For example, the fingerprint image can be captured at a low pressure range resulting in a less expanded fingerprint which in turn results in an image where the ridges and valleys are closer to each other. If the fingerprint is captured at a higher pressure range, the fingerprint image is expanded. Matching the fingerprint at more than one pressure, or at more than one pressure range results in more accurate fingerprint authentication than existing fingerprint authentication techniques.

In another embodiment of the invention, the method and system disclosed herein allows the capture of the fingerprint at a pre-specified pressure for a particular user.

The capture of the fingerprint at a pre-specified pressure, or a pre-specified pressure range makes the fingerprint recognition process more accurate and reduces the time taken for deriving the authentication decision.

### BRIEF DESCRIPTION OF THE DRAWINGS

The foregoing summary, as well as the following detailed description of the embodiments, is better understood when read in conjunction with the appended drawings. For the purpose of illustrating the invention, there is shown in the drawings exemplary methods and systems of the invention; however, the invention is not limited to the specific methods and instrumentalities disclosed herein.

FIG. 1 exemplarily illustrates a fingerprint capturing and recognition system for reducing the false rejection rate of biometric identification.

FIG. 2A exemplarily illustrates a method of capturing the fingerprint of a user at a pre-specified pressure.

FIG. 2B exemplarily illustrates a method of capturing the fingerprint of a user at a pre-specified pressure range.

FIG. 2C exemplarily illustrates the flow chart of the method of capturing the fingerprint of a user at a pre-specified pressure range.

FIG. 3 exemplarily illustrates a pressure sensing module.

FIG. 4A exemplarily illustrates a piezoelectric pressure sensor.

FIG. 4B exemplarily illustrates a spring based flexible module.

FIG. 4C exemplarily illustrates a membrane based flexible module.

FIG. 4D exemplarily illustrates a flat spring based flexible module.

FIG. 4E exemplarily illustrates a U-shaped spring based flexible module.

FIG. 5 exemplarily illustrates a circuitry for actuating fingerprint capture at a pre-specified pressure or within a pre-specified pressure range using an operational amplifier.

FIG. 6 exemplarily illustrates a flowchart for actuating the capture of a fingerprint at a pre-specified pressure.

### DETAILED DESCRIPTION OF THE INVENTION

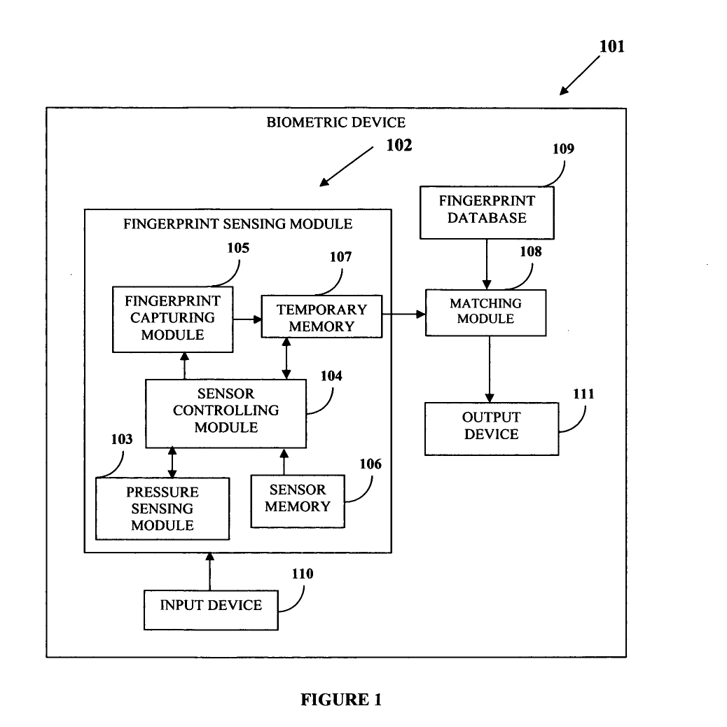

FIG. 1 illustrates a fingerprint capturing and recognition system for reducing the false rejection rate of identification of an individual using his or her fingerprint. The method and system disclosed herein decreases the rejection rate in fingerprint capturing and authentication by the use of a pressure actuated fingerprint sensing module 102. A biometric device 101 for fingerprint recognition of a user comprises a fingerprint sensing module 102 for capturing the fingerprint image of the user at a pre-specified pressure or a pre-specified pressure range. The fingerprint sensing module 102 comprises a fingerprint capturing module 105, a pressure sensing module 103, a sensor memory 106 and a sensor controlling module 104. The pressure sensing module 103 measures the pressure applied by the finger on the fingerprint capturing module 105. The sensor memory 106 stores a pre-specified set of pressures or pressure ranges. The sensor controlling module 104 actuates the fingerprint capturing module 105 to capture of the fingerprint image when the pressure applied by the finger on the pressure sensing module 103 reaches the preset pre-specified pressure, or falls within the preset pressure range.

A temporary memory 107 stores the captured fingerprint. The biometric device 101 comprises a matching module 108 that compares the captured fingerprint against fingerprint templates stored in a fingerprint database 109. The fingerprint database 109 stores the fingerprint template and may also store the corresponding pressure applied by the finger on the fingerprint capturing module 105 when the fingerprint is captured for the fingerprint template. An input device 110 facilitates the administrator to set the pre-specified pressure. The input device 110 comprises a keypad, a touch screen, a voice input with a voice recognition unit, a magnetic reading device, a radio frequency identification reading device, a bar code reading device, a light pen, a keyboard, a mouse, a terminal, biometric readers, etc. An output device 111 displays the results of fingerprint authentication and the pre-specified pressure condition. The display unit 109 comprises a liquid crystal display (LCD), light emitting diode (LED), touch screen, etc. The output device 111 comprises a display device, voice synthesizer module or any combination thereof. The display device may display an indication that the pre-specified pressure or pressure range has been reached for fingerprint capture. The display device may also be used to render other pertinent information such as the pressure applied by the finger on the sensor and the authentication results.

The fingerprint templates are the fingerprint samples captured during registration. A fingerprint scanned during a recognition process is compared with the fingerprint templates stored in the fingerprint database 109.

The matching module 108 compares the captured fingerprint with the fingerprint templates stored in the fingerprint database 109. The entire process of comparing and matching of fingerprint may exemplarily be accomplished using different matching techniques such as minutia matching, correlation matching or ridge based matching. Different fingerprint image processing techniques may be used for parallel processing of the captured fingerprint image. Application of selective, plural and sequenced fingerprint recognition rules may be another embodiment of the invention. The selective, plural and sequenced fingerprint recognition rules, are explained in detail in the patent application titled “Selective, plural and sequenced (SPS) fingerprint recognition”, application Ser. No. 11/511,146 which is incorporated herein in its entirety.

Minutiae point matching may be applied for fingerprint recognition. Minutiae points are local ridge characteristics that occur at either a ridge bifurcation or a ridge ending. For the registered user's fingerprint image, all the minutiae points, orientations and structural relationship of the points are detected and stored in the form of templates. During matching, the minutiae points of the templates and the input fingerprint are compared using the fingerprint templates in the fingerprint database 109. In certain applications, the minutiae matching algorithms do not always provide reliable results. Error is generated due to poor quality images. As the matching is sequential, the error propagates from one stage to another. Therefore, to avoid such errors further image enhancement techniques are employed. The techniques further ensure that the required level of accuracy and reliability is achieved.

The algorithm for minutiae matching, in the first stage, determines the presence of the same minutiae, for example, a bifurcation. If the presence of the same minutiae is confirmed, then the algorithm goes on to check if the direction of minutiae flow is also the same as that in the fingerprint image present in the fingerprint database 109. The final step of the minutiae-matching algorithm takes place only after both these conditions are fulfilled. The locations of the minutiae are determined and a check is made to see if the minutiae occupy the same position relative to each other.

Minutiae matching algorithms address the errors occurring during feature extraction. There are two types of errors in feature extraction stages. One of the errors is missing minutiae, i.e., the inability to detect the minutia points present. Such errors occur due to noise or inadequate ridge structures. Another error is spurious minutia, i.e., the false determination of the presence of minutiae in place of another structure such as ridge, crease, and ridge break. This type of error depends on the performance of the feature extraction process.

Correlation matching is a technique that requires precise location of a registration point and is affected by image translation and rotation. But once this is taken care of, the technique provides significantly faster fingerprint matching. Thus, fingerprint correlation has improved performance over minutiae matching technique. In this approach, the similarity between two fingerprints, i.e., fingerprint matching is achieved using more than one method. This technique is useful in overcoming the shortcomings of an individual technique.

The matching techniques comprise a plurality of ridge based fingerprint recognition rules. Ridge feature matching is another technique depending on the method of feature extraction. The algorithm depends on extracting texture, shape, frequency orientation and other ridge characteristics for matching.

In one embodiment of the invention the system can also involve more than one matching techniques to assure high accuracy.

The fingerprint capturing module 105 captures the fingerprint and stores the fingerprint in the temporary memory 107. The fingerprint capturing module 105 comprises fingerprint sensors. The method and system disclosed herein supports a plurality of fingerprint sensor types comprising capacitive, thermal, optical, tactile, or ultrasonic sensors. The application of these sensors is determined by accuracy, user friendliness and time for processing.

The optical fingerprint sensors enable non-contact fingerprint image detection with a high degree of accuracy. Human fingers consist mainly of three layers, namely-scarfskin, inner skin and tissues under the skin. There are concavo-convex shaped formations, called ridges and valleys on the inner skin. The scarfskin shows these shapes present on the inner skin, these shapes define the fingerprint of the person. As light is transmitted through the tissue a unique pattern of transmittance of light depending on the concavo-convex formation on the inner skin is generated. Each fingerprint has a unique pattern of concavity and convexity and thus each of them generate a pattern that can be distinguished from another. These sensors have low maintenance, high resolution, and are resistant to shock and electrostatic discharge (ESD).

The capacitive fingerprint sensor, as the name implies, works on the principle of capacitance. Capacitance can be defined as the ability to hold electrical charge. The capacitive fingerprint sensor eliminates the limitations of optical scanners. Problems such as edge distortion, misaligned optics, low-image resolution and scratched platens can be easily done away with. Normally parallel plate sensors are employed. A capacitive fingerprint sensor may contain many thousands of capacitive plates, each of which has its own associated electrical circuitry embedded in the form of integrated chips. As soon as a finger is placed on the sensor, an extremely weak electrical charge is built up. This electrical current builds up in a pattern that is determined by the capacitances corresponding to the ridges, valleys and pores that characterize a fingerprint. Every fingerprint has a unique pattern associated with it. The sensor can be made more accurate and reliable using programmable logic internal to the capacitive sensor circuitry and it also makes it possible to adjust the sensor reception to different skin types and environmental conditions.

Thermal fingerprint sensors use micro heaters as the sensing element. The sensing elements are placed in an array. These are micro resistors made of sputtered, very fine platinum film and are placed on a flexible polyamide film substrate. A temperature difference exists between the skin ridges and the air entrapped in the fingerprint valleys. The sensor measures and uses this temperature differential to map the fingerprint image. The advantage of using this method is that it is capable of generating a high quality image even on poor quality fingerprints like finger that are dry, worn or with little depth between the peaks and valleys of the fingerprint. It can also be used under adverse conditions like extremes of temperature, high humidity, dirt, and oil or water contamination.

Another type of sensor commonly used for fingerprint sensors is the tactile fingerprint sensor. It works on the principle of change in resistivity of a piezoresistive material. As a user passes his finger over the sensor, deflections in the micro-beam occur. This deflection corresponds to the ridges and the valleys that characterize the fingerprint. Fingerprint detection is based on the measurement of this deflection. The deflection can be measured by means of piezoresistive gauge. Resistivity change in the piezoresistive gauge is a measure of the deflection. The sensor includes electronic controls that are necessary to scan the row of microbeams and to amplify the signal from the gauges.

Ultrasonic sensors are also used for fingerprint recognition. They employ the basic theory of reflection, diffraction and scattering. When two solid objects are placed against each other, the contact between the surfaces of the two objects is not ideal, i.e., there are some inhomogeneities. As sound waves travel through these surfaces they undergo a phenomenon called contact scattering, along with getting reflected, diffracted and scattered as explained by classical theory of light. This phenomenon effects the sound propagation in the area of contact between the two objects. Using an ultrasonic camera the contact scattered rays are measured to generate the fingerprint image.

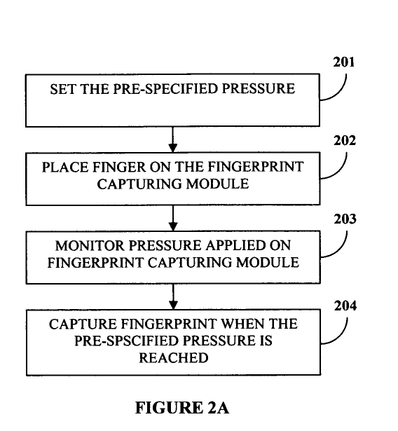

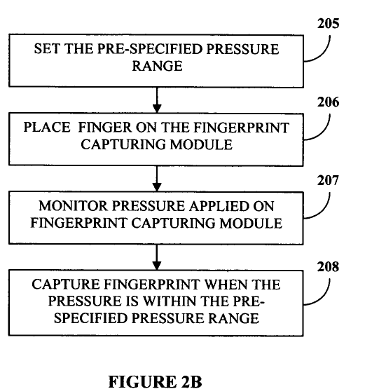

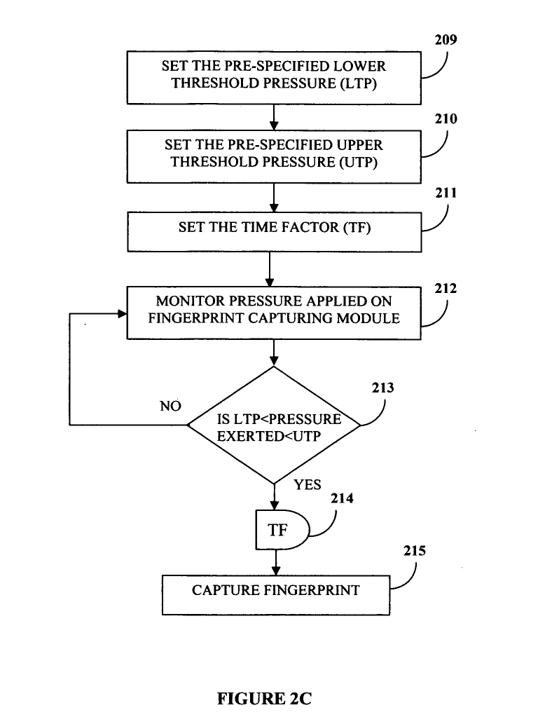

FIG. 2A exemplarily illustrates a method of capturing the fingerprint of a user at a pre-specified pressure. A pre-specified pressure at which the image of the fingerprint is captured is set 201 in the sensor controlling module 104. The administrator may set the pre-specified pressure, or it can be chosen from the pre-defined set of pre-specified pressures, set in the sensor controlling module 104 during manufacture of the fingerprint sensing module 102. The pre-specified set of pressures is stored in the sensor memory 106. A finger is placed 202 on the fingerprint capturing module 105. The pressure applied by the finger on the fingerprint capturing module 105 is monitored 203 by the pressure sensing module 103. The image of the fingerprint is captured 204 when the pressure applied by the finger on the pressure sensing module 103 reaches the pre-specified pressure.

The pre-specified pressure may further comprise a threshold pressure, and a time factor. The threshold pressure is the minimum pressure that needs to be applied by the finger on the fingerprint capturing module 105 to allow the capture of the fingerprint. The time factor is the minimum time for application of pressure by the finger on the fingerprint capturing module 105, above the threshold pressure for effectively capturing the fingerprint.

The pre-specified pressure can be chosen from a stored list of pressures stored in the sensor memory 106. In one embodiment of the invention, if the biometric device 101 is used in conjunction with a PIN based authentication, a user specific pre-specified pressure may be applied. Hence, in the case of a system with a PIN based first level authentication, a plurality of pre-specified pressures for a plurality of users may be set. The list of pressures is prepared during the registration of a user and updated during subsequent registrations of new users. The user or administrator may set the pre-specified pressure at the same pressure or at different pressures for different users. Consequently the fingerprint of users may be captured at different pre-specified pressures, and the fingerprint of a given user may be captured at a specific pre-specified pressure. The list of pressures is stored in a sensor memory 106. The pressure at which the fingerprint capturing module 105 is activated for capture the image of the fingerprint may also be altered or reset later to user specific and suitable conditions.

In another embodiment of the invention, the pre-specified pressure is set based on the finger size of the user. The sensor controlling module 104 decides the pre-specified pressure condition for the user. For example, the pre-specified pressure for a child with a small finger may be different than that for an adult with larger finger area.

FIG. 2B exemplarily illustrates a method of capturing the fingerprint of a user at a pre-specified pressure range. A pre-specified pressure range is set 205 at which the image of the fingerprint is captured in the sensor controlling module 104. The administrator may set the pre-specified pressure range or it can be chosen from the pre defined set of pre-specified pressure ranges, set in the sensor controlling module 104 during manufacture of the fingerprint sensing module 102. The set of pre-specified pressure range is stored in the sensor memory 106. A finger is placed 202 on the fingerprint capturing module 105. The pressure applied by the finger on the fingerprint capturing module 105 is monitored 203 through the pressure sensing module 103. The fingerprint is captured 204 when the pressure applied by the finger on the sensing module 102 falls within the pre-specified pressure range.

The pre-specified pressure range may further comprise an upper threshold pressure, a lower threshold pressure and a time factor. The upper threshold pressure is the maximum pressure that may be applied on the fingerprint capturing module 105 below which the fingerprint is captured. The lower threshold pressure is the minimum pressure that has to be applied by the finger on the fingerprint capturing module 105 to capture the fingerprint. The time factor is the minimum time for application of pressure by the finger on the fingerprint capturing module 105, within the pre-specified pressure range for effectively capturing the fingerprint.

The pre-specified pressure range can be chosen from a stored list of pressure ranges. In one embodiment of the invention, if the biometric device 101 is used in conjunction with a PIN based authentication, a user specific pre-specified pressure range may be applied. Hence, in the case of a system with a PIN based first level authentication, a plurality of pre-specified pressure range for a plurality of users may be set. The profile of a user can be determined by the PIN based authentication scheme. In another embodiment of the invention, an approximation of the area of the fingerprint captured during a fingerprint scan may be used to derive the optimum pressure range that has to be reached on the biometric device to actuate fingerprint capture. The list of pressure ranges is prepared during the registration of a user and updated during subsequent registrations of new users. The user or administrator may set the pre-specified pressure range. Consequently the fingerprint of users may be captured at different pre-specified pressure ranges, and the fingerprint of a given user may be captured at a specific pre-specified pressure range. The list of pressure ranges is stored in a sensor memory 106. The pressure range may also be altered or reset later to user specific and suitable ranges.

In another embodiment of the invention, pre-specified pressure ranges are applied according to the finger size of the user. The sensor controlling module 104 decides the pre-specified pressure range for the user. For example, the pre-specified pressure range for a child with a small finger may be different than that for an adult with a larger finger area.

FIG. 2C exemplarily illustrates the flow chart of the method of capturing the fingerprint of a user at a pre-specified pressure range. The pre-specified pressure range comprises a lower threshold pressure (LTP), and a time factor (TF). The pre-specified lower threshold pressure (LTP) and the pre-specified upper threshold pressure (UTP) are set by the user 209, 210. The time factor is the minimum time interval for which pressure applied by the finger is maintained within the pre-specified pressure range to capture the fingerprint. The time factor is set 211. The pressure applied on the fingerprint capturing module 105 is monitored 212. The threshold pressures (LTP and UTP) are compared with the applied pressure 213. If the applied pressure is higher than the pre-specified lower threshold pressure (LTP), or lower than the pre-specified upper threshold pressure (UTP), a delay determined by the time factor is introduced 214, which is the minimum time interval for which pressure applied by the finger is maintained within the pre-specified range to allow capture of the fingerprint. After the delay, the fingerprint is captured 215.

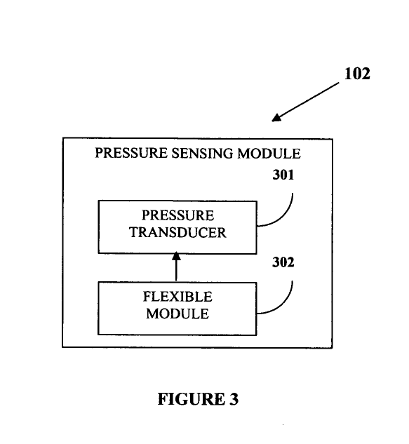

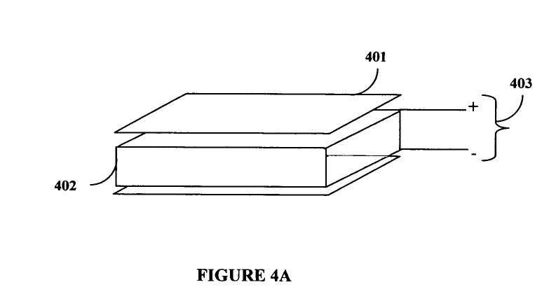

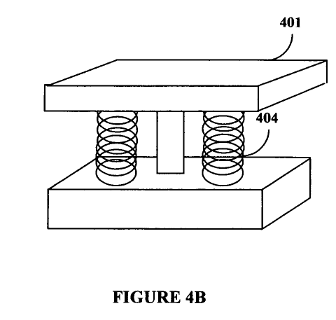

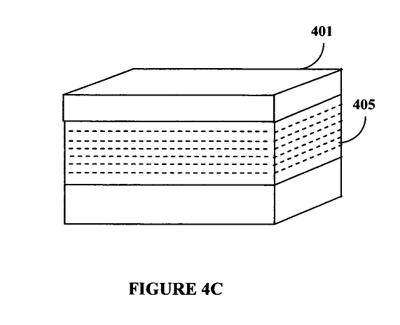

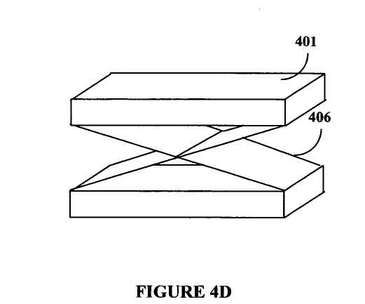

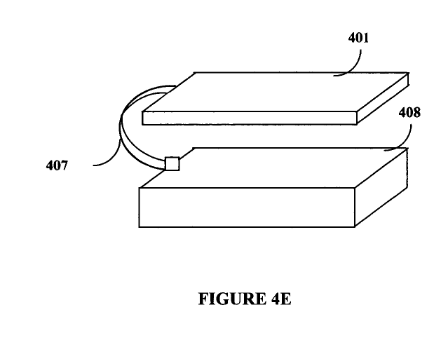

FIG. 3 illustrates the pressure sensing module 103. The pressure sensing module 103 comprises of a pressure transducer 301 and a flexible module 302 shown in FIGS. 4B-4E. The flexile module can be membrane based flexible module, a spring based flexible module, a flat spring based flexible module, a U-shaped spring based flexible module, etc.

The method and system disclosed herein supports a plurality of pressure sensor types comprising piezoelectric, capacitive, silicon, strain gage, resonant wire pressure sensors, etc. The application of these pressure sensors is determined by accuracy, user friendliness and time for processing.

Primary elements used in pressure transducers may be based on strain gauges, bellows and diaphragms. Bellows and diaphragms or pneumatic capsules are pneumatic devices.

Pressure sensor techniques and types can be classified into a multiplicity of types. Some of the pressure sensors and their working are explained below.

FIG. 4A exemplarily illustrates a piezoelectric pressure sensor. In a piezoelectric pressure sensor, the pressure-sensing 401 element is a diaphragm. The diaphragm 401 comprises a stack of disks made of piezoelectric ceramics or crystalline quartz 402. The face of the stack picks up the electrical charges when pressure is applied on the diaphragm 401. The electric charges 403 are proportional to the pressure applied. Hence, the pressure applied is determined in terms of electric charges 403 induced in the piezoelectric diaphragm. The electric charges are calibrated in terms of pressure.

Capacitive pressure sensor determines the pressure applied corresponding to a change in capacitance. The capacitance values are calibrated in terms of pressure. Capacitive sensor employs a thin diaphragm as a flexible element. The diaphragm acts as one of the plates of a capacitor, which is usually made of thin metal or metal-coated quartz. The pressure exerted on the diaphragm causes a flex, thereby causing a corresponding change in capacitance. The change in capacitance is converted into a corresponding pressure value.

Silicon pressure sensors comprise piezoresistors embedded under a thin face of chemically etched silicon diaphragm. Piezoresistors act as sensing elements. Due to the application of pressure, the diaphragm is flexed. The deformation causes a corresponding change in the resistance value of the piezoresistor. Silicon pressure sensors are accurate and compact sized.

Strain gage sensors are based on the fact that changes in strain on certain metals and semiconductors result in a corresponding change of their electrical resistance. Strain gages are useful for narrow spans of measurement and for differential pressure measurements.

Resonant wire sensor module comprise a wire stretched between a static member and a diaphragm. Due to the flexure of the diaphragm the tension in the wire varies and consequently the resonant frequency of vibration of the wire changes. The change in frequency corresponds to the pressure applied. A digital counter circuit measures the change in frequency and converts into corresponding pressure modules.

FIG. 4B exemplarily illustrates a spring based flexible module. The spring based flexible module comprises a sensing surface 401 and a curved spring 404.

FIG. 4C exemplarily illustrates a membrane based flexible module. The membrane based flexible module comprises a sensing surface 401 and a flexible membrane(s) 405.

FIG. 4D exemplarily illustrates a flat spring based flexible module. The flat spring based flexible module comprises a sensing surface 401 and a flat spring 406.

FIG. 4E exemplarily illustrates a U-shaped spring based flexible module. The U-shaped spring based flexible module comprises a sensing surface 401 and a curved spring 407 attached at one end to the sensing surface and at the other end to a base 408.

Pressure transducers 301 are devices that convert the pressure exerted on the fingerprint capturing module 105 into an electrical output such as voltage. The electrical output is used to compare the pressure exerted with the threshold pressure. Pressure comparison may be achieved by an operational amplifier as described below.

The output of the flexible module 302 is coupled to the pressure transducer 301. The output of the pressure transducer 301 is a voltage. Voltage measurement is used to derive the pressure applied by the finger on the pressure sensing module. The threshold pressure and the applied pressure are compared using a comparator. In one embodiment of the invention, the comparator used is an operational amplifier 503. In another embodiment of the invention, the comparator is software implemented.

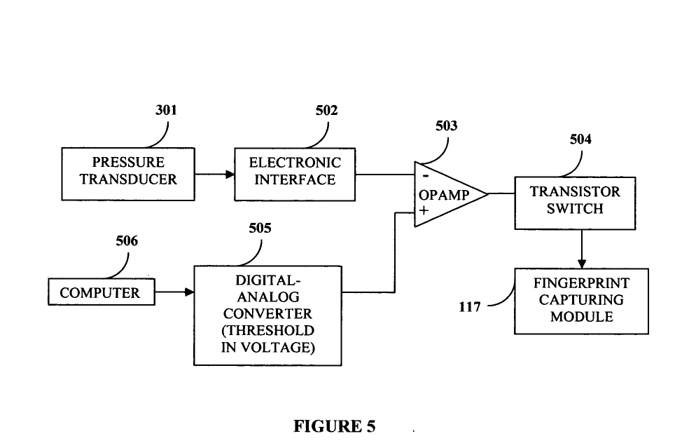

FIG. 5 exemplarily illustrates a circuitry for actuating fingerprint capture at a pre-specified pressure, or within a pre-specified pressure range using an operational amplifier. A voltage representing the applied pressure is fed as one of the inputs to a comparator, which is the operational amplifier 503. The voltage representing the applied pressure is obtained from the pressure transducer 501 through the electronic interface 502. The other input to the operational amplifier 503 is a threshold reference voltage representing the threshold pressure. The threshold pressure value is inputted by a user into a computer 506. The computer 506 computes the equivalent digital voltage value of the threshold pressure value. The digital voltage value is converted into an analog voltage using a digital-analog converter 505. The output of the operational amplifier 503 is coupled to a transistor switch 504 which controls the fingerprint capturing module 105. The threshold reference voltage is the factor that sets a switch trip point in the transistor switch. The electronic interface 502, the operational amplifier 503 and the transistor switch 504 are components of the sensor controlling module 104.

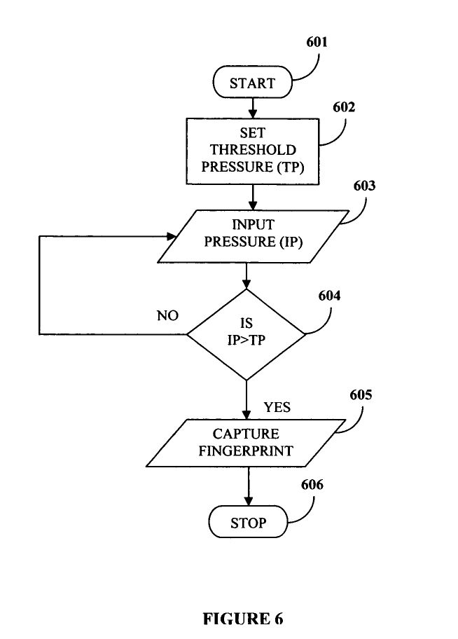

FIG. 6 exemplarily illustrates a flowchart for actuating the capture of a fingerprint at a pre-specified pressure or pressure range using software. The threshold pressure (TP) is initially 601 set 602 by the user. The pressure applied on fingerprint capturing module 105 is the input pressure (IP) 603. The threshold pressure is compared with input pressure 604. If the applied pressure or the input pressure is greater than the threshold pressure, the fingerprint is captured 605 at the end 606 of the process flow of FIG. 6. In another embodiment of the invention, the pre-specified pressure is substituted by a pre-specified pressure range.

It will be readily apparent that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code.

Where databases are described, such as the fingerprint database 109, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel.™., Pentium.™., or Centrino.™. processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A biometric device for fingerprint-recognition of a user, comprising:
a fingerprint sensing module for capturing the fingerprint image of said user at a pre-specified pressure, further comprising:
a fingerprint capturing module for capturing said fingerprint image;
a pressure sensing module for measuring the pressure applied on said fingerprint capturing module;
a sensor memory for storing said pre-specified pressure; and
a sensor controlling module for actuating the capture of said fingerprint image at said pre-specified pressure.

2. The system of claim 1, wherein said pre-specified pressure comprises a threshold pressure, and a time factor.

3. The system of claim 2, wherein said threshold pressure is the pressure applied on the fingerprint capturing module sensor above which the fingerprint is captured.

4. The system of claim 2, wherein said time factor is the minimum time interval for which pressure applied by the finger has to be maintained at the pre-specified pressure to capture the fingerprint.

5. The system of claim 1, wherein the pre-specified pressure can be set at any pressure stored in the sensor memory.

6. The system claim 1, wherein the biometric device further comprises a temporary memory for storing a captured fingerprint.

7. The system claim 1, wherein the biometric device further comprises a fingerprint database for storing fingerprint templates of registered users.

8. The system claim 1, wherein the biometric device further comprises a matching module for comparing said captured fingerprint with fingerprint templates.

9. The system claim 1, wherein the biometric device comprises an input device for inputting the pre-specified pressure.

10. The system claim 1, wherein the biometric device comprises an output device for displaying the authentication result.

11. The system of claim 10, wherein the output device displays an indicator when the pre-specified pressure is met.

12. The system of claim 1, wherein said fingerprint capturing module comprise a capacitive fingerprint sensor, optical fingerprint sensor, thermal fingerprint sensor, a tactile fingerprint sensor, an ultrasonic fingerprint sensor, etc.

13. The system of claim 1, wherein the pressure sensing module comprise a piezoelectric pressure sensor, capacitive pressure sensor, a silicon pressure sensor, a strain gage pressure sensor and a resonant wire pressure sensor, etc.

14. The system claim 1, wherein said pressure sensing module comprises a flexible module, and a pressure transducer.

15. The system of claim 15, wherein said flexible module comprises a curved spring, a U shaped spring, a flat spring and a flexible membrane.

16. The system of claim 1, wherein fingerprint templates are generated using the fingerprint samples captured during registration.

17. A method of capturing the fingerprint of a user at a pre-specified pressure comprising the steps of:
setting a pre-specified pressure at which the fingerprint is captured;
placing a finger on a fingerprint capturing module;
monitoring pressure applied by the finger on the fingerprint capturing module; and,
capturing the fingerprint when the pressure applied by the finger on the fingerprint capturing module reaches the pre-specified pressure.

18. The method of claim 17 wherein said pre-specified pressure is set depending on a user profile.

19. The method of claim 18 wherein said user profile is determined after authentication buy a personal identification number based initial authentication, prior to capturing the fingerprint.

20. A method of capturing the fingerprint of a user at a pre-specified pressure range comprising the steps of:
setting a pre-specified pressure range for capture of the fingerprint;
placing a finger on a fingerprint capturing module;
monitoring pressure applied by the finger on the fingerprint capturing module; and,
capturing the fingerprint when the pressure applied by the finger on the fingerprint capturing module is within the pre-specified pressure range.

21. The method of claim 20, wherein said pre-specified pressure range comprises a lower threshold pressure, an upper threshold pressure, and a time factor.

22. The method of claim 21, wherein said lower threshold pressure is the minimum pressure applied by the finger on the fingerprint capturing module for capture of the fingerprint.

23. The method of claim 21, wherein said upper threshold pressure is the maximum pressure applied by the finger on the fingerprint capturing module above which the fingerprint is not captured.

24. The method of claim 21, wherein said time factor is the minimum time interval during which pressure needs to be applied by the finger on the fingerprint capturing module within the pre-specified pressure range to allow capture of the fingerprint.

25. The method of claim 20, wherein the pre-specified pressure range can be selected from a stored list of pressure ranges.

26. The method of claim 20, wherein said pressure ranges are stored in said sensor memory.

27. The method of claim 20, wherein the user sets the pre-specified pressure range.

28. The method of claim 20, wherein the pre-specified pressure range is set depending on a profile of the user.
